(19) United States
(12) Patent Application Publication
(10) Pub. No.: US 2022/0327180 A1
(43) Pub. Date: Oct. 13, 2022

(54) GENERIC IMAGE RESIZER USING MATRIX MULTIPLIER ACCELERATOR

(71) Applicant: Texas Instruments Incorporated, Dallas, TX (US)

(72) Inventors: Deepak PODDAR, Bengaluru (IN); Soyeb NAGORI, Bengaluru (IN); Pramod SWAMI, Bengaluru (IN)

(21) Appl. No.: 17/489,998

(22) Filed: Sep. 30, 2021

Related U.S. Application Data
(60) Provisional application No. 63/173,581, filed on Apr. 12, 2021.

(51) Int. Cl. G06F 17/16; G06F 7/78; G06F 9/50

(52) U.S. Cl. CPC G06F 17/16; G06F 7/78; G06F 9/5027

(57) ABSTRACT

Techniques for resizing data including receiving input data values for resizing, placing a first number of data values from a first line of data values of the input data values in a first portion of a first vector, placing the first number of data values from a second line of data values of the input data values in a second portion of the first vector, receiving a first matrix of weights, wherein each weight of the first matrix of weights corresponds to an amount of weight to apply to a data value for a point on a first line of a set of resized data, multiplying the first vector and the first matrix of weights to determine data values for the first line of the set of resized data, and outputting the set of resized data.

### CROSS-REFERENCE TO RELATED APPLICATIONS

This application claims priority to U.S. Provisional Application No. 63/173,581, filed Apr. 12, 2021, which is hereby incorporated by reference.

### BACKGROUND

Machine learning (ML) is becoming an increasingly important part of the computing landscape. Machine learning is a branch of artificial intelligence (AI), and ML helps enable a software system to learn to recognize patterns from data without being directly programmed to do so. Neural networks (NN) are a type of ML which utilize a set of linked and layered functions (e.g., nodes, neurons, etc.) which are weighted to evaluate input data. In some NNs, sometimes referred to as convolution NNs (CNNs), convolution operations are performed in NN layers based on inputs received and weights. CNNs are often used in a wide array of applications typically for recognition and classification, such as image recognition and classification, prediction and recommendation systems, speech and language recognition and translation, etc. Layers in NNs may perform many types of functions, including, but not limited to, convolution, deconvolutional, pooling, up-sample, matrix multiplication, etc. Certain layers of NN may also perform operations such as resizing the inputs for use by another layer. For example, a layer of a NN recognizer may resize a portion of an input image to the layer (e.g., as intermediate data) for output to another layer for semantic segmentation of the portion of the input. Techniques for increasing performance of resizing operations may be useful.

### SUMMARY

This disclosure relates to a technique for resizing data via matrix multiplication including receiving input data values for resizing. The technique further includes placing a first number of data values from a first line of data values of the input data values in a first portion of a first vector. The technique also includes placing the first number of data values from a second line of data values of the input data values in a second portion of the first vector. The technique further includes receiving a first matrix of weights, wherein each weight of the first matrix of weights corresponds to an amount of weight to apply to a data value for a point on a first line of a set of resized data. The technique also includes multiplying the first vector and the first matrix of weights to determine data values for the first line of the set of resized data and outputting the set of resized data.

Another aspect of the present disclosure relates to an electronic device, the electronic device including one or more processors, wherein the one or more processors are configured to execute instructions causing the one or more processors to receive input data values for resizing. The instructions further cause the one or more processors to place a first number of data values from a first line of data values of the input data values in a first portion of a first vector. The instructions also cause the one or more processors to place the first number of data values from a second line of data values of the input data values in a second portion of the first vector. The instructions further cause the one or more processors to receive a first matrix of weights, wherein each weight of the first matrix of weights corresponds to an amount of weight to apply to a data value for a point on a first line of a set of resized data. The instructions also cause the one or more processors to multiply the first vector and the first matrix of weights to determine data values for the first line of the set of resized data and output the set of resized data.

Another aspect of the present disclosure relates to a non-transitory program storage device comprising instructions stored thereon to cause one or more processors to receive input data values for resizing. The instructions further cause the one or more processors to place a first number of data values from a first line of data values of the input data values in a first portion of a first vector. The instructions also cause the one or more processors to place the first number of data values from a second line of data values of the input data values in a second portion of the first vector. The instructions further cause the one or more processors to receive a first matrix of weights, wherein each weight of the first matrix of weights corresponds to an amount of weight to apply to a data value for a point on a first line of a set of resized data. The instructions also cause the one or more processors to multiply the first vector and the first matrix of weights to determine data values for the first line of the set of resized data and output the set of resized data.

### BRIEF DESCRIPTION OF THE DRAWINGS

For a detailed description of various examples, reference will now be made to the accompanying drawings in which:

FIG. 1 is a block diagram of a device, including hardware for executing ML models, in accordance with aspects of the present disclosure.

FIG. 2 is a block diagram illustrating bilinear data interpolation, in accordance with aspects of the present disclosure.

FIGS. 3A-1 and 3A-2 are block diagrams illustrating a 2× bilinear data interpolation, in accordance with aspects of the present disclosure.

FIGS. 3B, 3C, 3D, and 3E are block diagrams illustrating data objects, in accordance with aspects of the present disclosure.

FIGS. 4A-4C are block diagrams illustrating resizing a set of input data points, in accordance with aspects of the present disclosure.

FIG. 5 is a block diagram illustrating contents of multiple vectors, in accordance with aspects of the present disclosure.

FIG. 6A is a block diagram illustrating techniques for padding, in accordance with aspects of the present disclosure.

FIG. 6B is a block diagram illustrating a permute pattern, in accordance with aspects of the present disclosure.

FIG. 6C is a block diagram illustrating a vector, in accordance with aspects of the present disclosure.

FIG. 7A is a conceptual drawing illustrating a 4× data resizing, in accordance with aspects of the present disclosure.

FIG. 7B is a conceptual drawing illustrating contents of multiple vectors, in accordance with aspects of the present disclosure.

FIG. 8 is a is a flowchart illustrating a technique for resizing data, in accordance with aspects of the present disclosure.

### DETAILED DESCRIPTION

As ML has becoming more common and powerful, hardware, such as embedded device, have configured to execute ML models has been introduced. As used herein, an ML model may refer to an implementation of one or more ML algorithms which model a behavior, such as object recognition, behavior of a circuit, behavior of a neuron, etc. In many cases, an executing a ML model may resize data. To help increase performance for resizing input data, some devices, such as a system on a chip (SoC), digital signal processor (DSP), embedded system, etc., may include a hardware resizer, which may be circuits on the device dedicated for resizing data. However, in some cases, the hardware resizer may not share certain memories, such as cache memories like a level 1 (L1) or level 2 (L2) cache, with a processor, such as a central processing unit (CPU), graphics processing unit (GPU). ML accelerator, etc. For example, ML model may be executing on a CPU and/or ML accelerator of a device using an L2 cache. This L2 cache may be a relatively high speed, on-chip memory, such as static random access memory (SRAM). The hardware resizer may not be able to directly access this cache memory. In cases where a resize layer of the ML model is sandwiched between other layers, data for input to the resize layer may need to be written from the cache memory to another memory prior to executing the resize layer on the hardware resizer. This other memory may be relatively slower than lower level cache memories, such as the L2 cache memory, or L1 cache memory. Loading data from the ML model into another memory (and the subsequent reloading of output of the resize layer into L2) can slow down the execution of the resize layer specifically and the ML model as a whole. To help increase ML execution performance, a technique to perform data resizing within a matrix multiplication accelerator may be used.

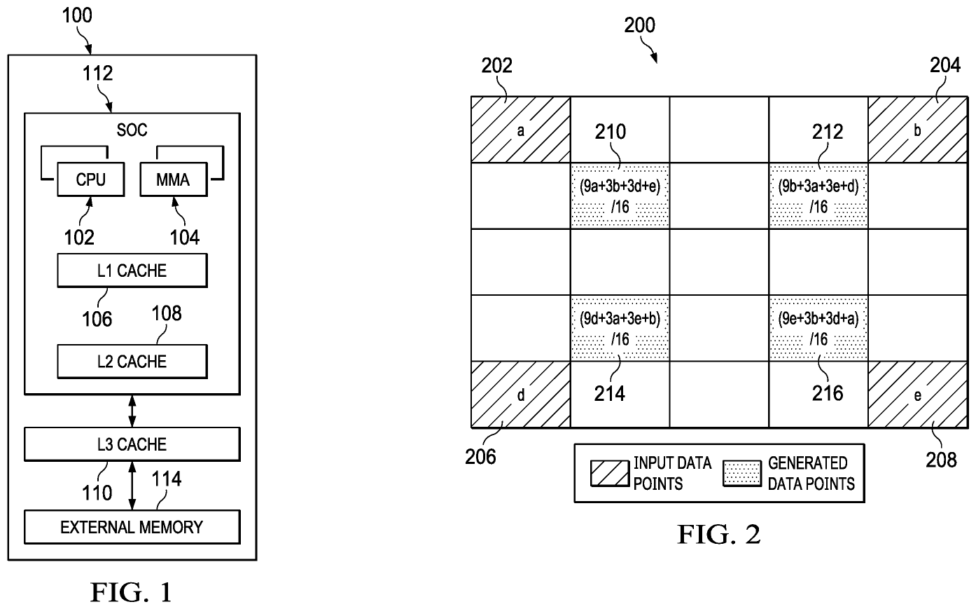

FIG. 1 is a block diagram of a device 100, including hardware for executing ML models, in accordance with aspects of the present disclosure. The device 100 may be SoC, including multiple components configured to perform different tasks. As shown, the device includes one or more CPU cores 102, which may include one or more internal cache memories (not shown). The CPU cores 102 may be configured for general computing tasks. The device 100 also includes one or more matrix multiplier accelerators (MMAs) 104. The MMAs 104 may be a circuit configured to perform multiple parallel operations on input data such as those often used for matrix multiplication and/or for processing layers of a ML model. In many cases, the MMAs 104 are configured to take, as input, a vector and a matrix, multiple the matrix and the vector and output a resulting matrix.

The processing cores, such as CPU cores 102 and MMAs 104, may be able to access one or more common caches shared between the processing cores. In this example, the processing cores may access a L1 cache 106, an L2 cache 108 and an L3 cache 110. In some cases, the processing cores and one or more caches, here the L1 cache 106 and L2 cache 108, may be integrated on a single chip, such as a SoC 112. The L3 cache 110 and external memory 114 may be on one or more chips separate from the SoC 112. Additionally, an external memory 114 may also be provided. The external memory 114 may be any kind of memory storage including double data rate (DDR) random access memory, other types of random access memory, flash memory, hard disk, etc.

In many cases, access to the memories and other components on the SoC 112, such as between the CPU cores 102, MMAs 104, L1 cache 106, and L2 cache 108, may be substantially faster than accessing components separate from the SoC 112, such as the L3 cache 110 and external memory 114. As such, it can be more efficient to do as much processing as possible when executing the ML model on components within the SoC 112.

Often when resizing data, additional data is added to enlarge the data from the original size to the new size. In many cases, this additional data is not simply a copy of the existing data. Rather, this additional data may be interpolated from the existing data. Interpolation estimates new data values based on existing data values using one or more functions. One technique that may be used when interpolating one dimensional data is linear interpolation based on the existing data. Linear interpolation applies essentially a weighted average of the existing data points to estimate the additional data. Linear interpolation may be extended into multiple dimensions conceptually as bilinear, trilinear, etc. interpolation. Data resize via interpolation may be applied to any type of data including, but not limited to image data, sensor data, set of numbers, etc.

FIG. 2 is a block diagram 200 illustrating bilinear data interpolation, in accordance with aspects of the present disclosure. As shown, a bilinear data interpolation operation operates on data defined by two variables and may be represented on a two-dimensional grid. In some cases, image data may be resized using bilinear data interpolation. In this example, input data points 202, 204, 206, and 208 may be the input data for a 2× resizing. Here in this example, data point 202 has a value of a, data point 204 has a value of b, data point 206 has a value of d, and data point 208 has a value of e. In a 2× resizing, one additional data point may be generated on each axis for each data point and the value of the generated data point may be an average of the values of the nearest input data points weighted based on distances between the generated data point and the nearest input data points. In some cases, for a bilinear data interpolation, each additional data point may be between four input data points, which are the nearest input data points (assuming the input data points are on the border).

In certain cases, weights may be predetermined based on distance for each of the four nearest input data points. For example, a size of the input data may be known, as well as distances as between the input data points, and how much resizing to perform (e.g., 2×, 4×, 6×, etc.). From this, weights may be predetermined for each of the generated data points to be determined. The predetermined weights may then be stored and loaded along with the ML model. Where multiple resizings are performed, different set of predetermined weights may be stored for the resizings. For example, a 2× resizing may not share predetermined weights used for a 4× resizing. In some cases, a set of predetermined weights may be shared across more than one resize operations. For example, multiple 2× resizings may use the same set of predetermined weights. In some cases, weighting based on distances from the neighbors may be referred to as nearest neighbor interpolation. It should be understood that while the example provided applies nearest neighbor interpolation, the specific technique for determining and applying weights to the input data points does not matter so long as the weights are deterministic for each generated data point.

In this example, the nearest input data points are weighted with integers such that the closest input data point (of the nearest input data points) is weighted with a value of 9, the next two closest input data points (which are equally distant) are weighted with a value of 3, and the furthest input data point (of the nearest input data points) is weighted with a 1. The nearest input data points for generated data points 210, 212, 214, and 216 are input data points 202, 204, 206, and 208. For generated data point 210, the closest to input data point is input data point 202 and the value of input data point 202 may be weighted with a value of 9. Values of input data point 204 and input data point 206 are weighted with a value of 3 and the value of input data point 208 is weighted with a value of 1. Thus, the value of generated data point 210 is a function (9a+3b+3d+e)/16. Similarly, the value of generated data point 212 is (9b+3a+3e+d)/16, the value of generated data point 214 is (9d+3a+3e+b)/16, and the value of generated data point 216 is (9e+3b+3d+a)/16.

Calculating the values for the generated data on a conventional CPU for a 2× resize operation on four input data points then requires 16 multiplication operations (four for each generated data point) as well as 16 register level data movements, and four elements round and shift operations (one for each generated data point for the division operation). To help reduce a number of operations needed for generate the generated data points, it may be beneficial to use the MMAs 104 to parallelize multiple multiplication operations for execution together.

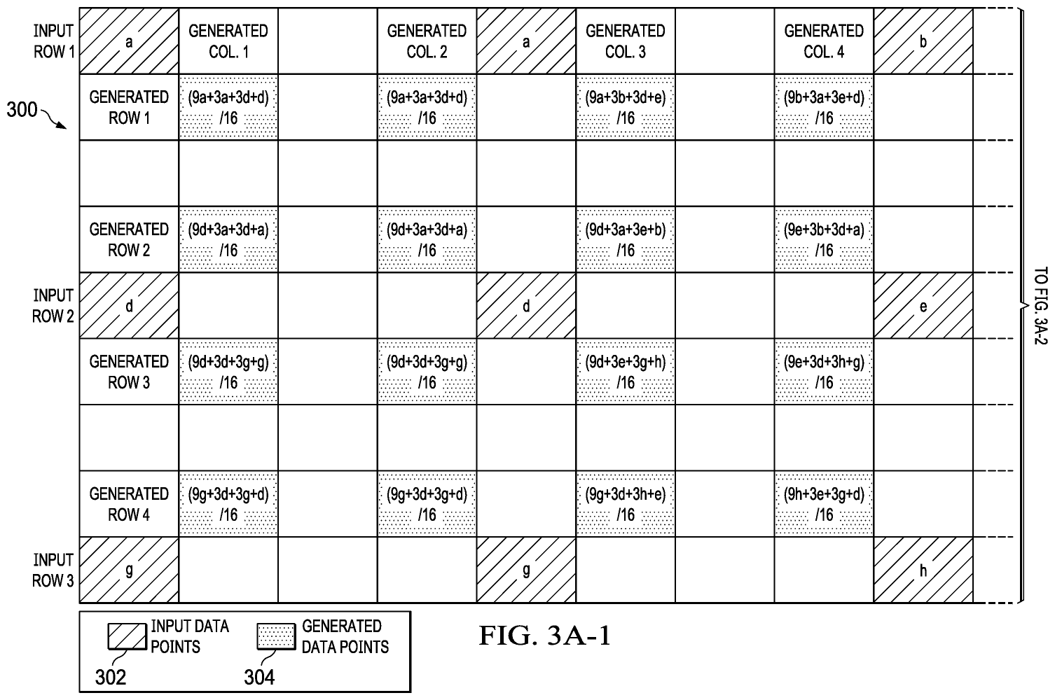

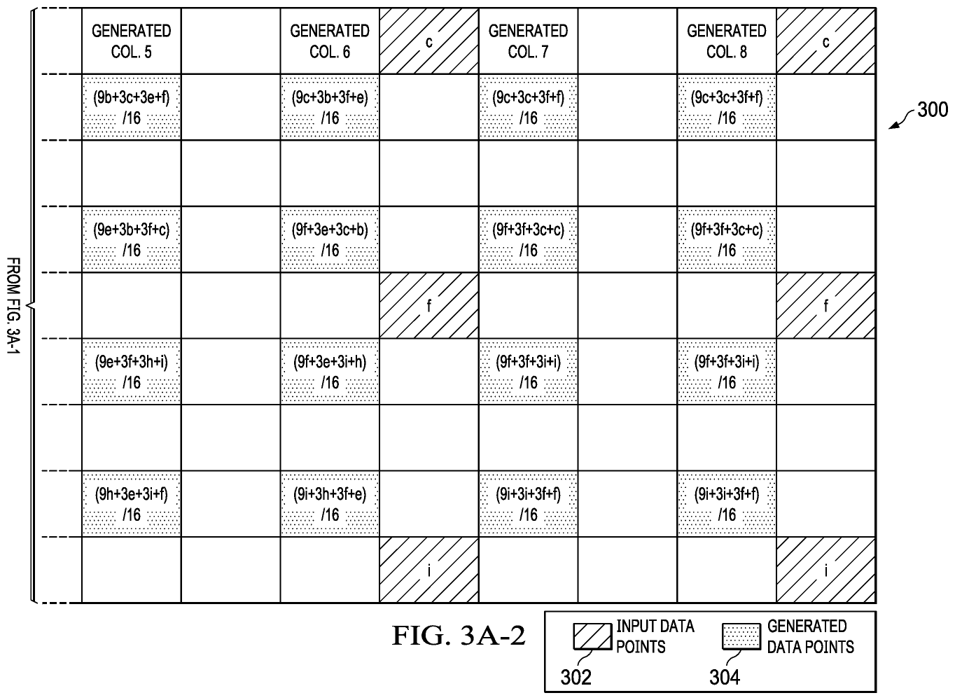

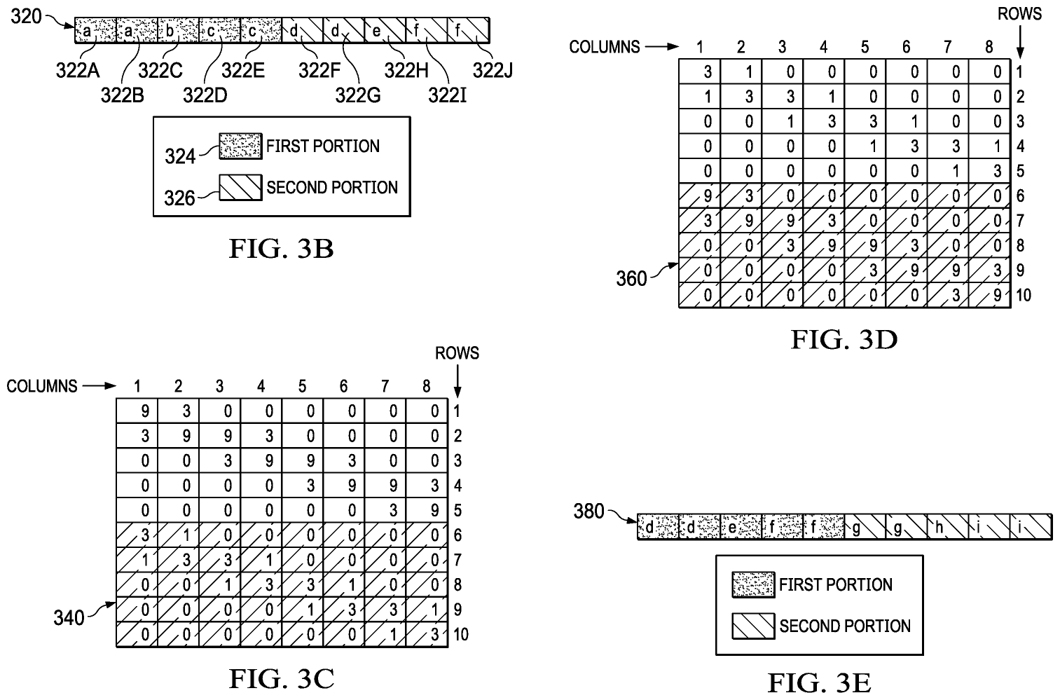

FIG. 3A is a block diagram 300 illustrating a 2× bilinear data interpolation, in accordance with aspects of the present disclosure. The diagram 300 shows a 2× resizing of a 3×5 (width×height) set of input data points 302, extending the example presented in FIG. 2 with additional data points. As shown, data values for the input data points 302 in input row 1 are a, a, b, c, c. Data values for the input data points 302 for input row 2 are d, d, e, f, f, and data values for the input data points 302 of input row 3 are g, g, h, l, and i. The MMAs 104 generally accept as input data, a vector and a matrix and the input data points 302, along with weights to be applied to the input data points 302 may be converted to the vector/matrix format. In accordance with aspects of the present disclosure, the values of the input data points 302 may be placed into vectors and the weights may be placed into matrices.

FIGS. 3B, 3C, 3D, and 3E are block diagrams illustrating data objects, in accordance with aspects of the present disclosure. FIG. 3B shows the contents of a vector 320 that may be input to the MMA. In some cases, values of the input data points may placed into a vector based on a pattern. For example, to determine a line of values for generated points, values of the input data points for a first line (e.g., row) may be concatenated with values of the input data points for a second line. In this example, the values of the input data points in input row 1 of diagram 300 are a, a, b, c, c. These values are placed in a first portion 324 (i.e., cells 322A-322E) of the vector 320. The values of the input data points for a next line, here input row 2 of diagram 300, are d, d, e, f, f, and these values are placed in a second portion 326 (i.e., cells 322F-322J) of the vector 320. Placing two lines of values into a single vector may help generate a full set of values for generated data points between the two lines. While shown in this example as rows, it should be understood that the lines of values may be organized along any dimension, such as a column, or by depth.

FIG. 3C shows the contents of a matrix 340 that may be input to the MMA along with vector 320. In some cases, weights to be applied to the values of the input data points may be placed into matrix 340 based on a pattern. The specific pattern may depend on how the input data points are placed into the vector 320 and a set of values for generated data points being determined. In this example, the weights for a 2× resizing of the input data points 302 are shown placed in a pattern in matrix 340 based on how the input data points 302 are placed in vector 320 for determining values for generated row 1. How the values of the input data points are placed in the vector may determine how the weights may be placed in the matrix. In some cases, a matrix with appropriate pattern of weights may be predefined. For example, one or more matrices with values may be stored and loaded along with the ML model.

Values in the vector 320 may be multiplied against values of the matrix 340 in a specific way as a part of matrix multiplication by the MMA based on matrix multiplication principles. In this example, values for the generated data points in generated row 1 of diagram 300 may be determined by the MMA by multiplying a value of cell 322A with a weight in col. 1, row 1 of matrix 340 (i.e., 9a); multiplying a value of cell 322B with a weight in col. 1, row 2 (i.e., 3a); multiplying a value of cell 322C with a weight in col. 1, row 3 (i.e., Ob) and so forth until the values of vector 320 are multiplied with respective values in col. 1 of matrix 340. These multiplied values may then be summed to determine the value of the generated data point in generated row 1, generated col. 1 of diagram 300. Of note, as values for the second line of input data points were concatenated with input data points of the first line, weighted values for all four nearest input data points are a determined in a matrix multiplication pass of the MMA for a generated data point.

Similarly, a value for the generated data point in generated row 1, generated col. 2, of diagram 300, may be determined by the MMA by multiplying a value of cell 322A with a weight in col. 2, row 1 of matrix 340, then multiplying a value of cell 322B with a weight in col. 2, row 2, then multiplying a value of cell 322C with a weight in col. 2, row 3, and so forth until the values of vector 340 are multiplied with respective values in col. 2 of matrix 340. These multiple values may then be summed to determine the value of the generated data point in generated row 1, generated col. 2, of diagram 300. This process continues by multiplying each value in vector 320 with values in a corresponding column of matrix 340. The MMA may perform two or more of the multiplications of the vector values and the matrix values in parallel. The results of the multiplication of vector 320 and matrix 340 may be output as a vector which includes the values for the generated data points in generated row 1 of diagram 300.

Similarly, to determine values for the generated data points in generated row 2 of diagram 300, the vector 340 may be multiplied against matrix 360 of FIG. 3D. Similar to matrix 340, matrix 360 includes weights to be applied based on a pattern. Here, the pattern in which the weights are organized for matrix 360 differs from matrix 340 as matrix 360 is for generating values for data points in generated row 2. In some cases, a number of patterns for placing weights into matrices may correlate with the amount of resizing to be performed. For example, two patterns may be used for 2× resizing, while four patterns may be used for 4× resizing. Thus, in this example, when determining values for generated rows 1 and 3, matrix 340 may be used, when determining values for generated rows 2 and 4, matrix 360 may be used, and so forth.

In this example, to determine values for generated rows 3 and 4, input data from input rows 2 and 3 are used. Similar to vector 320, vector 380 shows values that may be input to the MMA. More specifically, here, vector 380 includes values of input data points corresponding to input row 2 of diagram 300 concatenated with input data points corresponding to input row 3 of diagram 300. As shown, vector 380 of FIG. 3E may be multiplied with matrix 340 to determine values for generated row 3 and vector 380 may be multiplied with matrix 360 to determine values for generated row 4.

In some cases, a set of vectors (e.g., as a matrix) of values of input data points may be prepared prior to beginning the matrix multiplication of vectors of the set of vectors against the matrices. For example, a matrix including vector 320 and vector 380 may be prepared and then vector 320 may be multiplied against matrix 340 and matrix 360 and vector 380 multiplied against matrix 340 and matrix 360.

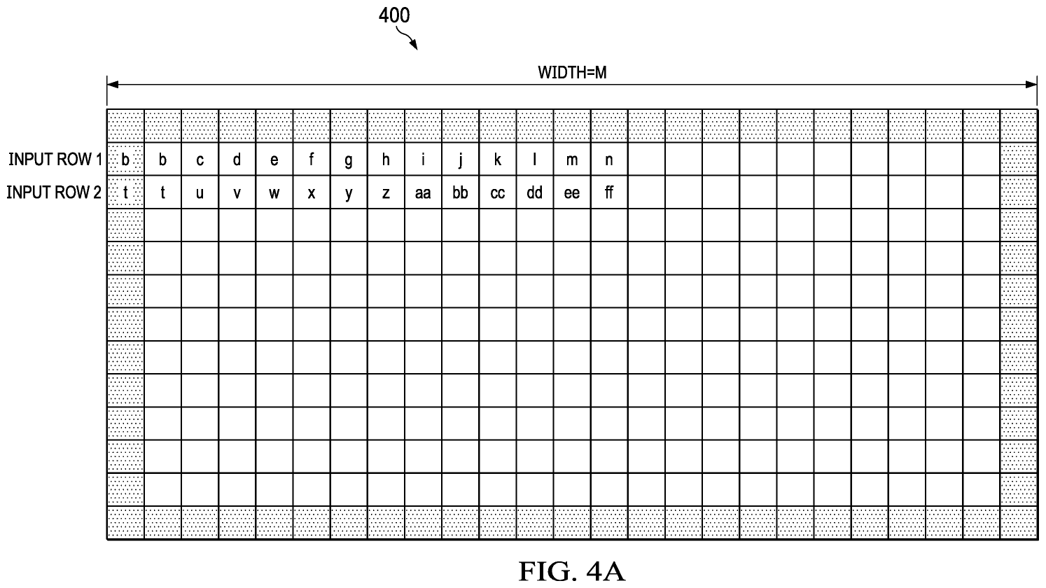

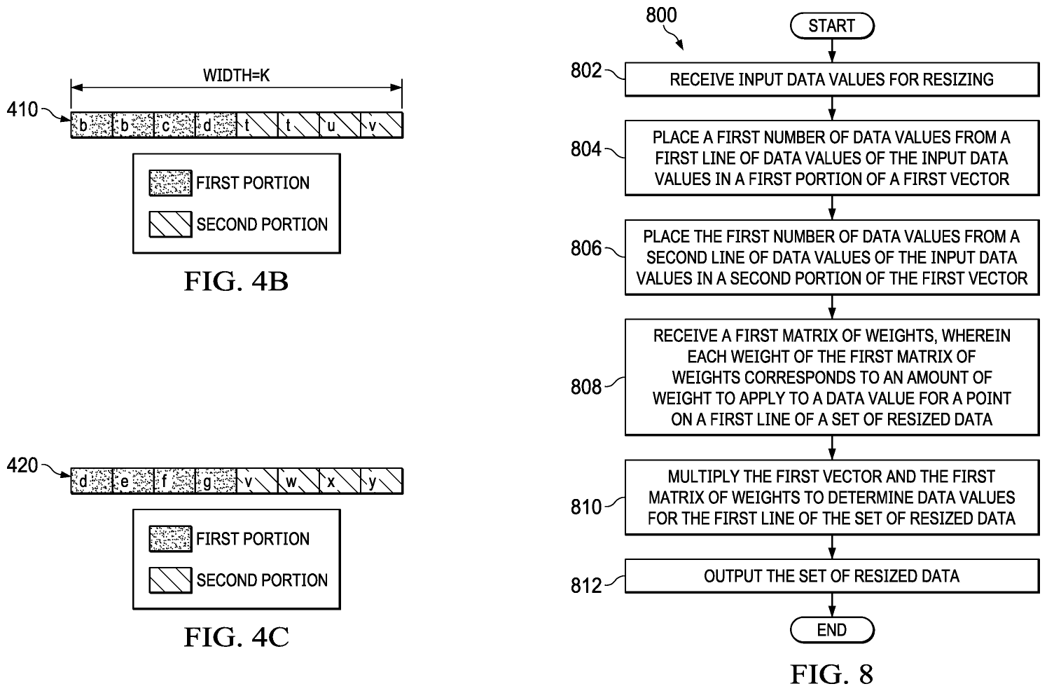

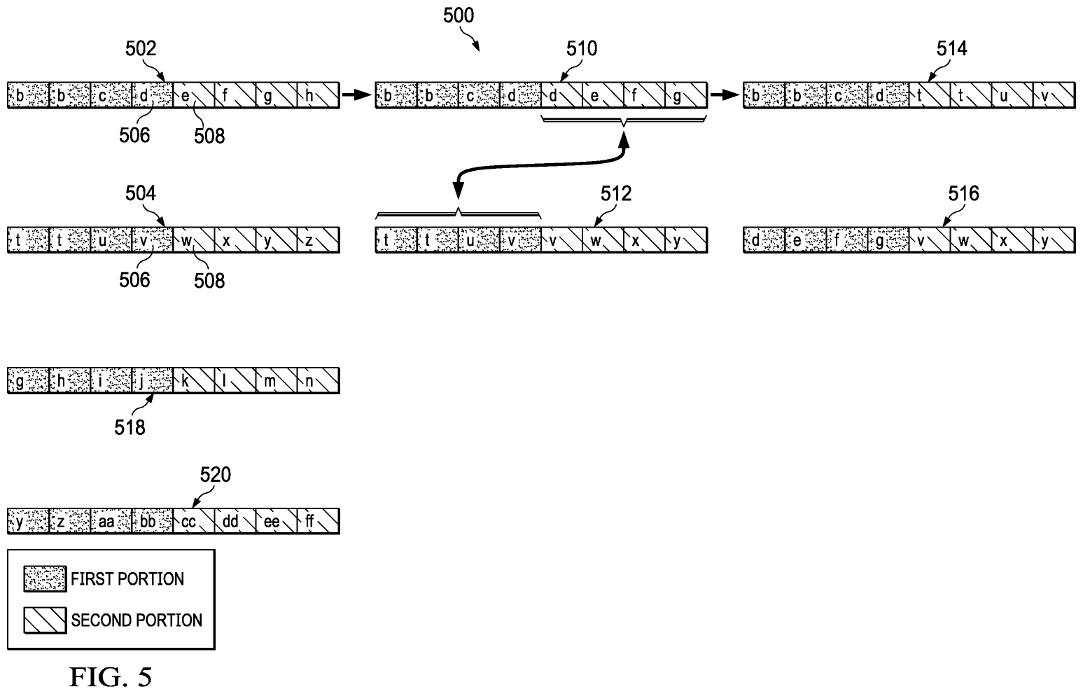

In some cases, a size (e.g., width and/or height) of the input data points exceeds the size of the vectors. For example, an MMA may be able to support multiplying a vector of a width K with a matrix with a width×depth of L×L, but the input data points may have width (e.g., a column size) M where M>L. In such cases, the input data points may be broken down into smaller sets of vectors for use with the MMA. FIGS. 4A-4C are block diagrams illustrating resizing a set of input data points, in accordance with aspects of the present disclosure. FIG. 4A, an input grid 400 is shown including input data points in each cell of the input grid 400. For input grid 400, a subset of input data values of the input data points are shown with the first row including the input data values of b, b, c, d, e, f, g, and h, while the second row includes the input data values of t, t, u, v, w, x, y, and z. Note that values in input grid 400 are edge padded, but this padding is discussed in more detail below and can be ignored for the discussion of FIGS. 4A-C and FIG. 5. As shown, the width of the input grid 400 is M. In this example, the MMA may accept a vector, such as vector 410 of FIG. 4B with a maximum width of K, which is smaller than M. In such cases, the input data points may be broken up into smaller chunks. In some cases, a first line (e.g., row) of values of a width K/2 may be placed into a first portion of the vector. In this example, as K=8, four values, the values b, b, c, and d, from input row 1 may be placed into the first portion of vector 410. Values from a next line of values may be concatenated with the first portion in a second portion of the vector. In this example, values t, t, u, v from input row 2, corresponding with the values placed in the first portion of the vector, may be placed in the second portion of vector 410. The resulting concatenated vector may then be multiplied with a corresponding matrix of weights, such as matrix 340 or 360.

A second vector, such as vector 420 of FIG. 4C, may include additional values for input data points from the two lines of values, picking up from where a previous vector stopped. Additional values from the first line of values of a width K/2 may be placed into a first portion of a current vector. In some cases, there may be an overlap of values from the previous vector. For example, a first value of a portion the current vector may overlap with a last value of a corresponding portion of the previous vector. As shown, previous vector 410 included values b, b, c, d from input row 1. Picking up where the previous vector 410 stopped for input row 1, the values d, e, f, and g may be placed in current vector 420. Value d may overlap and be included in both the previous vector 410 and the current vector 420 as the value of d may be used to determine generated values along with (at least) value c of pervious vector 410 and with value e of the current vector 420. Similarly, values from a next line of values may be concatenated with the first portion in a second portion of the vector. In this example, values v, w, x, and y from input row 2 may be placed in the second portion of vector 420. As with value d, value v may be included as the last value of the second portion of previous vector 410 and as the first value of the second portion of the current vector 420. Additional vectors may be used as need to cover all of the values in the lines of values.

In some cases, loading input data values into the vectors may be performed by the MMA. It may be understood that while the loading of the input data values may be performed by input/output components around (e.g., coupled to) core MMA hardware accelerator components, these components may be considered as part of the MMA. When performed by the MMA, placing less than K input data values into a vector at a time may be relatively inefficient as multiple external memory reads may be used per vector. In some cases, the MMA may be able to create multiple vectors.

FIG. 5 is a block diagram 500 illustrating contents of multiple vectors, in accordance with aspects of the present disclosure. As shown, FIG. 5 extends the previous example and illustrates two vectors, a first vector 502, and a second vector 504. The MMA may load, for example into registers of the MMA, K input data values into the first vector 502 from a first line, here values b, b, c, d, e, f, g, and h. The MMA may also load K input data values into the second vector 504 from the second line, here values t, t, u, v, w, x, y, and z. In some cases, the input data value in the K/2 position 506 of the vector (e.g., the last position of the first portion of the vector) may overlap and be duplicated into the K/2+1 position 508 of the vector (e.g., the first position of the second portion of the vector). As an example, the input data value in the K/2 position 506 of the first vector 502 is d and this value may be copied into the K/2+1 position 508 of the first vector 502 to generate third vector 510. In some cases, the value in the K position may be dropped. A register shift and insert operation may be used to perform the copying. Similarly, for the second vector 504, the value v may be copied from the K/2 position 506 of the second vector 504 into the K/2+1 position 508 to generate a fourth vector 512. In some cases, the third vector 510 and the fourth vector 512 may represent modified versions of the first vector 502 and second vector 504, respectively, rather than copies of the vectors.

Once the values have been copied, the second portion of the third vector 510 may be swapped for the first portion of the fourth vector 512 to generate a fifth vector 514. Similarly, the first portion of the fourth vector 512 may be swapped for the second portion of the third vector 510 to generate a sixth vector 516. In some cases, the vector 514 and the sixth vector 516 may represent modified versions of the first vector 502 and second vector 504, respectively. The fifth vector 514 and the sixth vector 516 may be multiplied with a corresponding matrix of weights, such as matrix 340 or 360. As modifying the vectors may occur within the MMA without additional memory requests to memories outside of the MMA, modifying a vector after loading data into the vector may be performed faster than loading the specific values from memory into the vector.

Additional vectors may be loaded from the first and second lines until the end of the lines of input grid 400 are reached. Of note, a value in the K position of a vector may be dropped (e.g., in third vector 510 and fourth vector 512) as compared to the originally loaded values of the first vector 502 and second vector 504 and an overlap of values from the previous vector may be applied. Therefore, the next vector, such as a seventh vector 518, may be loaded starting from the K-2 input data value of the respective rows. For example, the seventh vector 518 may load values from the first line starting at the K-2 input data value of the first vector 502, here the value g. Similarly, an eighth vector 520 may load values from second line starting at the K-2 input data value of the second vector 504, here the value y.

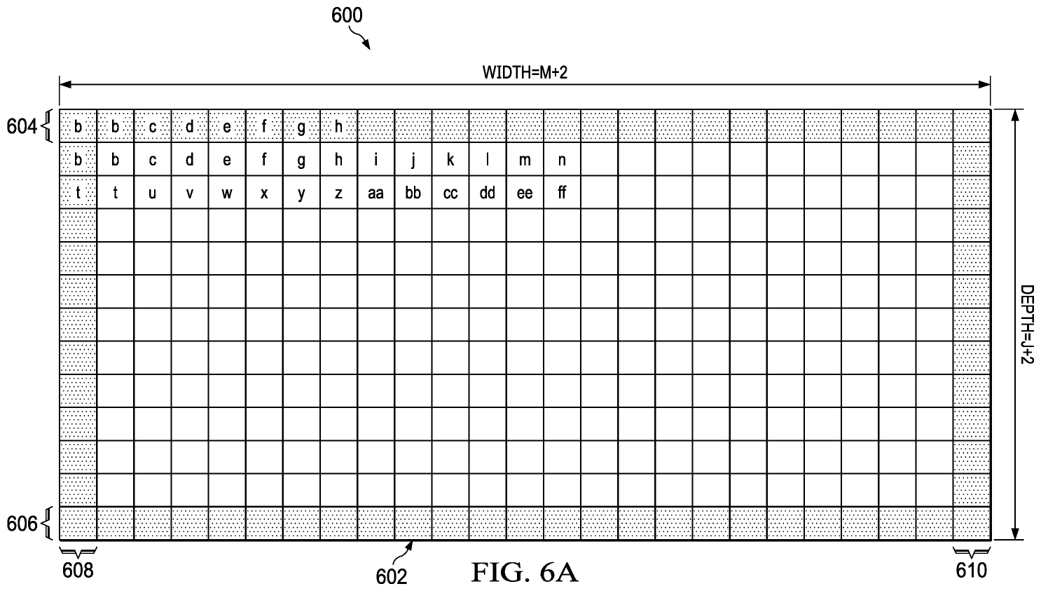

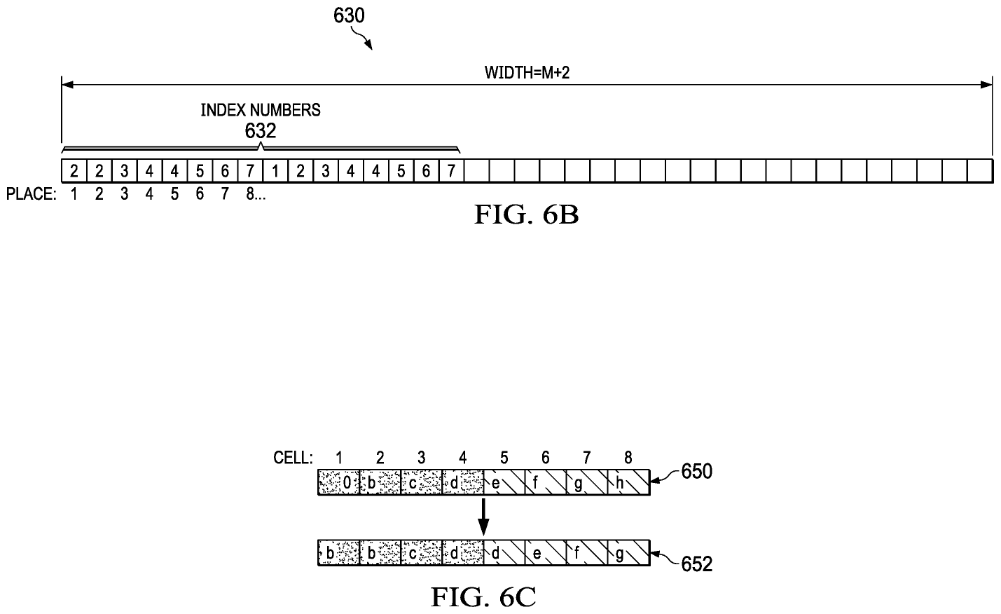

FIG. 6A is a block diagram 600 illustrating techniques for padding, in accordance with aspects of the present disclosure. In some cases, the input data points may be padded. For example, the input data points may be padded to obtain additional data points for interpolating input data points at edges of an input grid 602 of input data points. As shown, the input grid 602 may include M input data points in the columns and J input data points in the rows. The input data points may be padded on each edge of the input grid 602 such that a top pad 604, bottom pad 606, left pad 608, and right pad 610 may be added to the input grid 602 such that the total width of the input grid 602 after padding is M+2 and the total depth after padding is J+2. In some cases, values for the padded input data points may be copies of the nearest input data points. In some cases, padding may be performed at different points in time based on what data points are being padded. For example, the values for the top pad 604 and bottom pad 606 may be determined and added when the input data points are received for resizing. For example, when resizing is initialized on the input data points, the top pad 604 and bottom pad 606 may be determined based on values in the top-most line of the input data points and the values in the bottom-most line of the input data points. In some cases, a one dimensional set of data, may be resized using a top pad, bottom pad, left pad, and right pad. Thus, the one dimensional set of data may be expanded into two dimensions.

In some cases, the left and right pads 608 and 610 may be dynamically determined. For example, pad values corresponding to the left and right pads 608 and 610 may be added to vectors as needed after loading values of input data points into the vector. The pad values may be added along with coping the overlap data values and swapping a second portion of a first vector with a first portion of a second vector as described in conjunction with FIG. 5. Padding may be added along the edges of the of the input grid 602, but may not be added when values of input data points not along the edge. For example, a vector including values b, c, d, e, f, g, and h may include a pad such that the values in the vector, after padding, are b, b, c, d, e, f, g, and h. Other vectors, such as a vector including values y, z, aa, bb, cc, dd, ee, and ff may not need padding as the input data points are not along the edge of the input grid 602. In some cases, a determination whether a pad may be added to a vector may be made on a per vector basis.

In some cases, a determination whether pad values may be added to a vector may be based on a permute pattern. In some cases, the permute pattern may be predetermined. For example, permute patterns may be determined based width of the input data points. These permute patterns may be stored and loaded along with the ML model. In some cases, the permute patterns may be included with the ML model. FIG. 6B illustrates a permute pattern 630, in accordance with aspects of the present disclosure. As shown, the permute pattern 630 includes values corresponding to an index number 632 of the value in the vector to use for determining the pad values and the overlap values. The received input data values may be read according to the permute pattern 630. As an example, the input grid 602 may be initially padded on the left and right edges with default values, such as 0. The input data values, including the default values may be read into a first vector, such as vector 502. Padding and overlap values may be determined based on the permute pattern 630 by placing a value into the using values of the vector corresponding to the index number 632 of the permute pattern.

As an example, values of input data points may be read into vector 650 FIG. 6C. In this example, the input data points included an initial pad of 0 on the left and right edges and this initial pad value of 0 is present in the first cell of vector 650. The permute pattern 630 may then be applied to cells of vector 650 by loading a value corresponding to the index number 632 from the permute pattern 630 from vector 650 into a cell of vector 650 being determined. For example, for cell 1 of vector 650, the index number 632 from corresponding place 1 of the permute pattern 630 is 2. Thus, the value of cell 1 is set to the value of cell 2 (i.e., b) based on the index number 632 from place 1 of the permute pattern 630, as shown in vector 652. Continuing the example, for cell 2 of vector 650, the index number 632 from corresponding place 2 of the permute pattern 630 is 2. Thus, the value of cell 2 remains set to the value of cell 2 (i.e., b), as shown in vector 652. Similarly, the value of cells 3 and 4 remain the same.

For cell 5 of vector 650, the index number 632 from corresponding place 5 of the permute pattern 630 is 4. Thus, the value of cell 5 of the vector 650 is set to the value of cell 4 of the vector 650 (i.e., d) based on the index number 632 from place 5 of the permute pattern 630, as shown in vector 652. By using the value of a first cell specified in the index number of the permute pattern 630 for determining a value for a second cell, the permute pattern 630 may be used to apply padding as well as overlapping for the vectors. In some cases, the permute pattern 632 may be predetermined. For example, the permute pattern may be determined based on expected input grid 602 dimensions and/or vector/matrix dimensions supported by the MMA. The permute pattern may be determined, for example as a part of development of a ML model and stored, for example, along with the ML model. In some cases, the permute pattern have a same width as the input grid 602, here M+2. In some cases, a single permute pattern may be reused for each row of the input grid. After the permute pattern 632 is applied to obtain the padded and/or overlapped vector 652, the vector 652 may be multiplied against a matrix of weights.

In some cases, a set of predetermined matrices of weights may be used. For example, as discussed above in conjunction with FIGS. 3A-3E, two matrices may be used to determine values for two generated rows. In a 2× resizing, two generated rows may be interpolated between two input rows. Each generated row may be associated with one of two matrices of weights. For example, generated rows 1, 3, etc. may be associated with matrix 340, and generated row rows 2, 4, etc. may be associated with matrix 360.

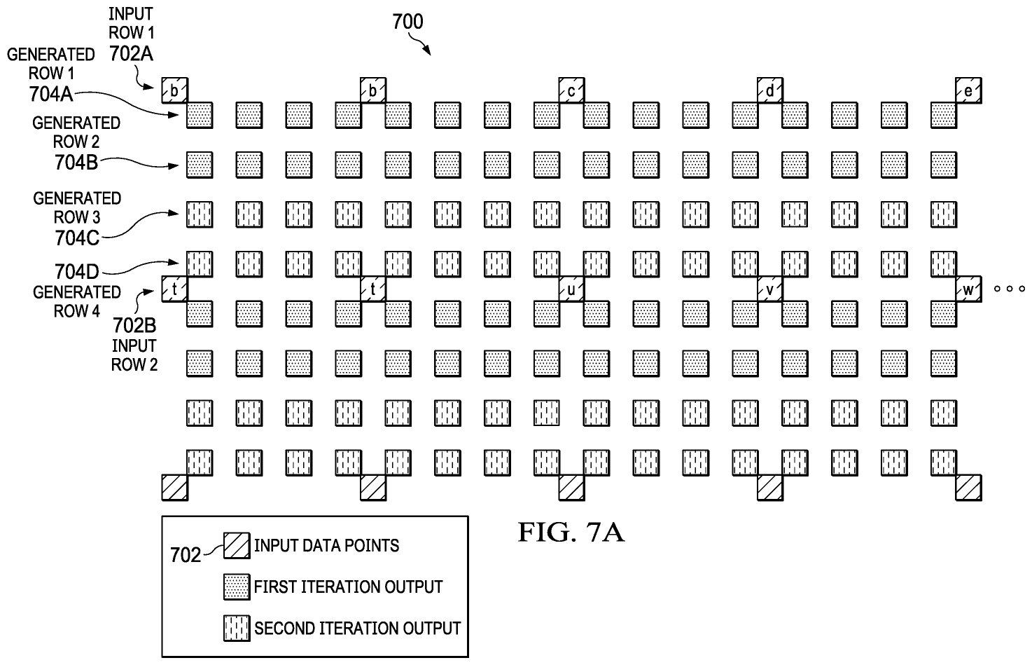

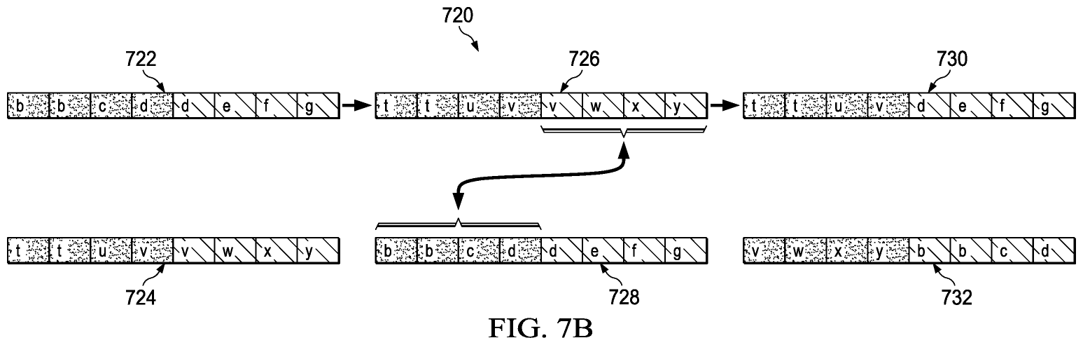

FIG. 7A is a conceptual drawing 700 illustrating a 4× data resizing, in accordance with aspects of the present disclosure. Similar to a 2× resizing, in a 4× resizing, four generated rows 704A-704D (collectively 704) may be interpolated between two input rows 702A and 702B and there may be four matrices of weights (not shown), one for each of the generated rows 704. In some cases, the MMA may include memory sufficient to load two matrices at a time. In such a case, when 4× resizing (or greater) is performed, the four matrices of weights may be swapped in and out of MMA memory as needed to determine values for the generated rows.

It may be observed that weights to be applied to input data points in generated row 3 704C and generated row 4 704D are an inverse of weights to be applied to input data points in generated row 2 704B and generated row 1 704A, respectively. In some cases, such as when performing a 4× resizing, determining values for generated row 1 704A and generated row 2 704B may be performed in a manner substantially similar to that described in conjunction with FIGS. 3A-3E, 4A-4C, and 5. Thus, the generated row 1 704A is associated with a corresponding first matrix of weights and generated row 2 704B is associated with a corresponding second matrix weights to be multiplied against. To help limit a number of matrices of weights, the vectors of input data values may be adjusted.

FIG. 7B is a conceptual drawing 720 illustrating contents of multiple vectors, in accordance with aspects of the present disclosure. Determining values for vectors of input data values for generated row 3 704C and generated row 4 704D may be performed using second iteration over the same weight matrices by inverting an order in which the input rows are placed into the vectors. As an example, to determine values for data points of generated row 1 and generated row 2, values of input data points from input row 1 702A may be placed into a first vector and padding and/or overlapping may be performed as described in conjunction with FIG. 5 to a first vector 722. The first vector 722 may then be multiplied against a first matrix of weights (not shown), the first matrix of weights including weights for determining values for generated row 1 704A. Similarly, input row 2 702B may be placed into a second vector 724 (with padding and/or overlapping). The second vector 724 may then be multiplied against a second matrix of weights (not shown), the second matrix of weights including weights for determining values for generated row 2 704B.

The MMA may then be configured to invert the order in which the input rows are placed into the vectors to determine values for generated row 3 704C and generated row 4 704D. To invert the order in which input rows are placed into the vectors, an indication may be provided to the MMA. In some cases, a flag may be set to apply the inverted order.

The MMA may then place values of input data points from input row 2 702B into a third vector 726 (with padding and overlapping). Similarly, values of input data points from input row 1 702B into a fourth vector 728 (with padding and overlapping). A second portion of the third vector 726 may be swapped for the first portion of the fourth vector 728 to generate a fifth vector 730. The third vector 726 may then be multiplied against the first matrix of weights (not shown) to determine values for generated row 3 704C. This first matrix of weights is the same matrix of weights used for determining values for generated row 1 704A. Similarly, the first portion of the fourth vector 728 may be swapped for the second portion of the third vector 726 to generate a sixth vector 732. The fourth vector 728 may then be multiplied against the second matrix of weights (not shown) to determine values for generated row 4 704D. This second matrix of weights is the same matrix of weights used for determining values for generated row 2 704B.

In some cases, the MMA may output results from the matrix multiplication sequentially for multiple generated rows. The MMA may accept certain sized inputs, such a vector having a width of K and a matrix having dimensions of L×L. Sometimes, a number of columns of input data points in an input row does not divide evenly by the width of vectors processed by the MMA. In such cases, for a last vector of input data points for a row, not all cells of the vector may be used and the remaining cells of the vector may be filled with unneeded data, such as zeros. When outputting values of a matrix multiplication using the last vector for the generated rows, a masked write may be used to avoid overwriting other data based on the unneeded data.

FIG. 8 is a is a flowchart 800 illustrating a technique for resizing data, in accordance with aspects of the present disclosure. At block 802, input data values are received for resizing. For example, a program, such as a ML model, executing on a device may receive data values, such as sensor data, an image, etc. and as a part of executing the ML model, the data values may be resized. In some cases, the resizing may be performed by a hardware MMA. At block 804, a first number of data values from a first line of data values of the input data values are placed in a first portion of a first vector. For example, the hardware MMA may perform matrix multiplication based on a vector and a matrix. A number of data values from a line of data values of the received data values may be placed in a first portion of the vector. As a more specific example, if MMA supports 8-bit vectors, the first half of a vector may be filled with data values from the first line of data. At block 806, the first number of data values from a second line of data values of the input data values are placed in a second portion of the first vector. For example, the second half of the vector may be filled with data values from the next line of data.

At block 808, a first matrix of weights is received, wherein each weight of the first matrix of weights corresponds to an amount of weight to apply to a data value for a point on a first line of a set of resized data. For example, resizing input data includes creating new generated data based on the input data. A generated data point of the generated data may be based on a weighted average of values of the input data at a number of points closest to the generated data point. The matrix of weights may describe weights to apply to the closest input data points for a line of generated data points. At block 810, the first vector is multiplied with the first matrix of weights to determine data values for the first line of the set of resized data. For example, the MMA may perform a matrix multiplication between the vector of input data values and the matrix of weights. At block 812 the set of resized data is output.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

A device that is “configured to” perform a task or function may be configured (e.g., programmed and/or hardwired) at a time of manufacturing by a manufacturer to perform the function and/or may be configurable (or re-configurable) by a user after manufacturing to perform the function and/or other additional or alternative functions. The configuring may be through firmware and/or software programming of the device, through a construction and/or layout of hardware components and interconnections of the device, or a combination thereof.

Unless otherwise stated, “about,” “approximately,” or “substantially” preceding a value means+/−10 percent of the stated value. Modifications are possible in the described examples, and other examples are possible within the scope of the claims.

What is claimed is:

1. A method for resizing data, comprising:
receiving input data values for resizing;
placing a first number of data values from a first line of data values of the input data values in a first portion of a first vector;
placing the first number of data values from a second line of data values of the input data values in a second portion of the first vector;
receiving a first matrix of weights, wherein each weight of the first matrix of weights corresponds to an amount of weight to apply to a data value for a point on a first line of a set of resized data;
multiplying the first vector and the first matrix of weights to determine data values for the first line of the set of resized data; and
outputting the set of resized data.

2. The method of claim 1, wherein multiplying the first vector and the first matrix of weights is performed by a matrix multiplier accelerator as a matrix multiplication operation.

3. The method of claim 1, wherein the first number of data values corresponds to half of a width of the first vector.

4. The method of claim 1, wherein placing the first number of data values from the first line of data values of the input data values in the first portion of the first vector comprises:
placing a second number of data values from the first line of data values of the input data values in the first vector, wherein the second number is twice the first number, and wherein the first vector includes two portions;
placing the second number of data values from the second line of data values of the input data values in a second vector, the second vector including two portions; and
replacing the second portion of the first vector with a first portion of the second vector.

5. The method of claim 4 further comprising:
receiving a second matrix of weights, wherein each weight of the second matrix of weights corresponds to an amount of weight to apply to a data value for a point on the second line of the set of resized data;
replacing the first portion of the second vector with the second portion of the first vector; and
multiplying the second vector and the second matrix of weights to determine data values for the second line of the set of resized data.

6. The method of claim 5, wherein the resizing comprises a four-times resizing, wherein the second line of data values is after the first line of data values, and wherein the method further comprises:
placing the second number of data values from the first line of data values of the input data values in the second vector;
placing the second number of data values from the second line of data values of the input data values in the first vector;
replacing the second portion of the first vector with the first portion of the second vector;
replacing the first portion of the second vector with the second portion of the first vector;
multiplying the first vector and the first matrix of weights to determine data values for a third line of the set of resized data; and
multiplying the second vector and the second matrix of weights to determine data values for a fourth line of the set of resized data.

7. The method of claim 1, further comprising:
adding a top pad to the input data values, wherein values for the top pad are based on a third line of data values of the input data values;
adding a bottom pad to the input data values, wherein values for the bottom pad are based on a fourth line of data values of the input data values;
determining a right pad based on a permute pattern, the permute pattern indicating locations for values of the first vector; and
modifying the first vector based on the locations for values of the first vector indicated by the permute pattern.

8. The method of claim 7, wherein the permute pattern indicates an overlap pattern for a value of the first vector.

9. An electronic device, comprising:
one or more processors, wherein the one or more processors are configured to execute instructions causing the one or more processors to:
receive input data values for resizing;
place a first number of data values from a first line of data values of the input data values in a first portion of a first vector;
place the first number of data values from a second line of data values of the input data values in a second portion of the first vector; and
receive a first matrix of weights, wherein each weight of the first matrix of weights corresponds to an amount of weight to apply to a data value for a point on a first line of a set of resized data;
multiply the first vector and the first matrix of weights to determine data values for the first line of the set of resized data; and
output the set of resized data.

10. The electronic device of claim 9, wherein at least one of the one or more processors comprise a matrix multiplier accelerator.

11. The electronic device of claim 9, wherein the number of data values corresponds to half of a width of the first vector.

12. The electronic device of claim 9, wherein the instructions further to place the first number of data values from the first line of data values of the input data values in the first portion of the first vector configure the one or more processors to:
place a second number of data values from the first line of data values of the input data values in the first vector, wherein the second number is twice the first number, and wherein the first vector includes two portions;
place the second number of data values from the second line of data values of the input data values in a second vector, the second vector including two portions; and
replace the second portion of the first vector with a first portion of the second vector.

13. The electronic device of claim 12, wherein the instructions further configure the one or more processors to:
receive a second matrix of weights, wherein each weight of the second matrix of weights corresponds to an amount of weight to apply to a data value for a point on the second line of the set of resized data;
replace the first portion of the second vector with the second portion of the first vector; and
multiply the second vector and the second matrix of weights to determine data values for the second line of the set of resized data.

14. The electronic device of claim 13, wherein the resizing comprises a four-times resizing, wherein the second line of data values is after the first line of data values, and wherein the instructions further configure the one or more processors to:
place the second number of data values from the first line of data values of the input data values in the second vector;
place the second number of data values from the second line of data values of the input data values in the first vector;
replace the second portion of the first vector with the first portion of the second vector;
replace the first portion of the second vector with the second portion of the first vector;
multiply the first vector and the first matrix of weights to determine data values for a third line of the set of resized data; and
multiply the second vector and the second matrix of weights to determine data values for a fourth line of the set of resized data.

15. The electronic device of claim 9, wherein the instructions further configure the one or more processors to:
add a top pad to the input data values, wherein values for the top pad are based on a third line of data values of the input data values;
add a bottom pad to the input data values, wherein values for the bottom pad are based on a fourth line of data values of the input data values;
determine a right pad based on a permute pattern, the permute pattern indicating locations for values of the first vector; and
modify the first vector based on the locations for values of the first vector indicated by the permute pattern.

16. The electronic device of claim 15, wherein the permute pattern indicates an overlap pattern for a value of the first vector.

17. A non-transitory program storage device comprising instructions stored thereon to cause one or more processors to:
receive input data values for resizing;
place a first number of data values from a first line of data values of the input data values in a first portion of a first vector;
place the first number of data values from a second line of data values of the input data values in a second portion of the first vector; and
receive a first matrix of weights, wherein each weight of the first matrix of weights corresponds to an amount of weight to apply to a data value for a point on a first line of a set of resized data;
multiply the first vector and the first matrix of weights to determine data values for the first line of the set of resized data; and
output the set of resized data.

18. The non-transitory program storage device of claim 17, wherein at least one of the one or more processors comprise a matrix multiplier accelerator.

19. The non-transitory program storage device of claim 17, wherein the instructions to place the first number of data values from the first line of data values of the input data values in the first portion of the first vector configure the one or more processors to:
place a second number of data values from the first line of data values of the input data values in the first vector, wherein the second number is twice the first number, and wherein the first vector includes two portions;
place the second number of data values from the second line of data values of the input data values in a second vector, the second vector including two portions; and
replace the second portion of the first vector with a first portion of the second vector.

20. The non-transitory program storage device of claim 17, wherein the instructions further configure the one or more processors to:
add a top pad to the input data values, wherein values for the top pad are based on a third line of data values of the input data values;
add a bottom pad to the input data values, wherein values for the bottom pad are based on a fourth line of data values of the input data values;
determine a right pad based on a permute pattern, the permute pattern indicating locations for values of the first vector; and
modify the first vector based on the locations for values of the first vector indicated by the permute pattern.
